(19) United States
(12) Patent Application Publication
(10) Pub. No.: US 2026/0125000 A1
(43) Pub. Date: May 7, 2026

(54) Tailgate Mat

(71) Applicant: Li HUANG, Guangzhou (CN)

(72) Inventor: Li HUANG, Guangzhou (CN)

(73) Assignee: Guangzhou Dingdian Technology Co., Ltd., Guangzhou (CN)

(21) Appl. No.: 19/437,225

(22) Filed: Dec. 30, 2025

(30) Foreign Application Priority Data
Dec. 15, 2025 (CN) 202522659663.0

(51) Int. Cl. B60R 13/01

(52) U.S. Cl. CPC B60R 13/01

(57) ABSTRACT

A tailgate mat for installation on a tailgate of a cargo compartment of a pickup truck, including: a border, which is configured to wrap around an upper end of the tailgate; a supporting component, which is located on the border. When the cargo compartment bears goods, a first end of the goods is abutted against a front bottom of the cargo compartment, and a second end of the goods is supported by the supporting component; an angle between a supporting force of the supporting component on the goods and a vertical direction is defined as a, and a is less than 45°, to provide more stable cushioning and better support for the goods. The border can wrap around the upper end of the tailgate, avoiding scratching and damage to the upper end of the tailgate during transportation or long sized goods.

### CROSS-REFERENCE TO RELATED APPLICATIONS

This application claims foreign priority of Chinese Patent Application No. 202522659663.0, filed on Dec. 15, 2025 in the China National Intellectual Property Administration, the disclosures of all of which are hereby incorporated by reference.

### TECHNICAL FIELD

The present disclosure relates to the technical field of automotive accessories, in particular to a tailgate mat used to protective a tailgate of a pickup truck.

### BACKGROUND

As a type of vehicle that serves both passenger and cargo purposes, pickup trucks are widely used by consumers because of their dual advantages of carrying people and goods. When pickups are used for transporting cargo, their open cargo beds facilitate loading and unloading. When transporting hard and long-sized materials, it is generally arranged in an inclined position, with one end resting on the bottom of the front end of the cargo bed, and the other end directly placed on the smooth edge of the tailgate. After arranging the cargo this way, it is fixed for transportation. This placement method makes the upper edge of the tailgate a stress point for the cargo, and during transport, due to road bumps or acceleration and deceleration of the pickup trucks, the cargo may scratch different degrees of the upper end of the tailgate. This not only causes local deformation or damage to the tailgate but may also shift the cargo. The tailgate mat was created to address this issue, typically wrapping around the tailgate to prevent scratching and damage from the cargo.

Most common tailgate mats on the market cover only the inner surface of the tailgate. However, such mats can only prevent damage to cargo that is entirely placed within the cargo compartment. For long-sized cargo that needs to rest on the upper edge of the tailgate, there are one-piece tailgate mats that completely cover the upper edge and inner surface of the tailgate. However, these mats usually fit tightly against the upper edge of the tailgate, making it difficult to disperse the pressure from the cargo when carrying long-sized items, leading to the damage and deformation of the tailgate mat.

To address these problems, the present disclosure offers a tailgate mat that effectively resolves the aforementioned issues, featuring a simple structure and good protective effects, providing excellent cushioning and shock-absorption capabilities.

### SUMMARY

In order to overcome the shortcomings of existing technology, the present disclosure provides a tailgate mat with a simple structure and good protective effect, which can play a good buffering and shock-absorbing role.

To realize the above objective, the present disclosure provides a tailgate mat for installation on a tailgate of a cargo compartment of a pickup truck, including: a border, which is configured to wrap around an upper end of the tailgate: a supporting component, which is located on the border: when the cargo compartment bears goods, a first end of the goods is abutted against a front bottom of the cargo compartment, and a second end of the goods is supported by the supporting component: an angle between a supporting force of the supporting component on the goods and a vertical direction is defined as a, a is less than 45°, to provide stable cushioning and support for the goods.

The beneficial effects of the present disclosure are as follows: Through the configuration described above, the border can wrap around the upper end of the tailgate, preventing scratching and damage to the upper edge of the tailgate when transporting long-sized cargo. The supporting part located on the border is directly used for bearing the weight of the cargo. When transporting long-sized items in the cargo bed, one end of the cargo rests against the bottom of the front end of the tailgate, while the other end is placed directly on the supporting part. This way, the inclined cargo is supported by the supporting part and the front end of the tailgate, concentrating the weight of the cargo on the supporting part and the front end of the tailgate.

### BRIEF DESCRIPTION OF DRAWINGS

In order to clearly illustrate the technical solutions of the embodiments of the present disclosure, the following is a brief description of the drawings that will be used in the description of the embodiments. The drawings mentioned in the following description are merely some embodiments of the present disclosure. For those skilled in the art, it is possible to derive other figures from these without the necessity of inventive effort.

The present disclosure will be further described in conjunction with the drawings and embodiments.

FIG. 1 is a schematic structural diagram of a tailgate mat at a first angle according to an embodiment of the present disclosure.

FIG. 2 is an enlarged view of an area E in FIG. 1.

FIG. 3 is a schematic structural diagram of the tailgate mat at a second angle according to an embodiment of the present disclosure.

FIG. 4 is a partial schematic structural diagram of the tailgate mat according to an embodiment of the present disclosure.

FIG. 5 is a side view of the tailgate mat according to an embodiment of the present disclosure.

FIG. 6 is a schematic diagram of a force analysis of a cargo on the tailgate mat when a tailgate is closed according to an embodiment of the present disclosure:

FIG. 7 is a schematic diagram of a force analysis of the goods according to an embodiment of the present disclosure:

FIG. 8 is an installation diagram of the tailgate mat with the tailgate closed.

FIG. 9 is an installation diagram of the tailgate mat with the tailgate opened.

FIG. 10 is an exploded diagram of the tailgate mat with the tailgate opened.

FIG. 11 is a schematic diagram of a first usage state of the tailgate mat with the tailgate closed.

FIG. 12 is a schematic diagram of a second usage state of the tailgate mat with the tailgate closed.

### DESCRIPTION OF THE REFERENCE NUMERAL

100 border, 110 protrusion, 111 bearing surface, 120 groove, 130 anti-slip inclined surface, 150 supporting component, 200 main body, 210 installation slot, 220 protruding strip, 230 fixing component, 240 installation hole, 300 cargo compartment, 310 tailgate, 400 goods.

### DETAILED DESCRIPTION OF THE EMBODIMENTS

To make the above objectives, features, and advantages of this disclosure more clearly understood, a detailed description of the specific embodiments of this disclosure is provided in conjunction with the accompanying drawings. Many specific details are elaborated upon in the following description to facilitate a thorough understanding of this disclosure. However, this disclosure can be implemented in many other ways not described herein, and those skilled in the art can make similar improvements without deviating from the essence of this disclosure. Therefore, this disclosure is not limited to the specific embodiments disclosed below.

In the description of this disclosure, it should be understood that if terms such as “center,” “longitudinal,” “transverse,” “length,” “width,” “thickness,” “top,” “bottom,” “front,” “back,” “left,” “right,” “vertical,” “horizontal,” “upper,” “lower,” “inner,” “outer,” “clockwise,” “counterclockwise,” “axial,” “radial,” “circumferential,” etc., appear, these terms refer to the positional relationships based on the orientations illustrated in the accompanying drawings, which are provided for the purpose of facilitating the description of this disclosure and simplifying the explanation, and do not indicate or imply that the described device or component must have a specific orientation, construction, and operation. Therefore, they should not be interpreted as limitations on this disclosure.

Furthermore, if terms like “first,” “second,” etc., appear, these terms are used solely for descriptive purposes and should not be interpreted as indicating or implying relative importance or suggesting the number of technical features indicated. Thus, the features labeled “first” or “second” may explicitly or implicitly include at least one of the features. In the embodiments of this disclosure, if the term “multiple” is used, it means at least two, such as two, three, etc., unless otherwise specified.

In this disclosure, unless otherwise explicitly stated, if terms like “mounted,” “connected,” “joining,” “fixed,” etc., are used, these terms should be understood in a broad sense. For example, it can refer to a fixed connection or a detachable connection or being integrated: it can be mechanical connections or electrical connections: it can be directly connected or indirectly connected through an intermediary, or it can refer to internal communication between two elements or the interaction between two elements, unless otherwise specifically defined. Those skilled in the art can interpret the specific meanings of these terms in this disclosure according to the specific context.

In this disclosure, unless otherwise explicitly stated, if descriptions such as the first feature being “above” or “below” the second feature appear, it means that the first and second features may be in direct contact or may be in contact indirectly through an intermediary. Additionally, the first feature being “above,” “on top of,” or “above” the second feature may mean that the first feature is directly above or at an angle above the second feature, or it may simply indicate that the first feature is at a higher horizontal height than the second feature. The first feature being “below,” “beneath,” or “under” the second feature may mean that the first feature is directly below or at an angle below the second feature, or it may simply indicate that the first feature is at a lower horizontal height than the second feature.

It should be noted that if a component is referred to as being “fixed to” or “arranged on” another component, it can be directly on another component or may have an intervening component. If a component is considered to be “connected” to another component, it may be directly connected to another component or may have an intervening component. The terms “vertical,” “horizontal,” “above,” “below,” “left,” “right,” and similar expressions are used solely for illustrative purposes and do not imply that there is only one mode of implementation.

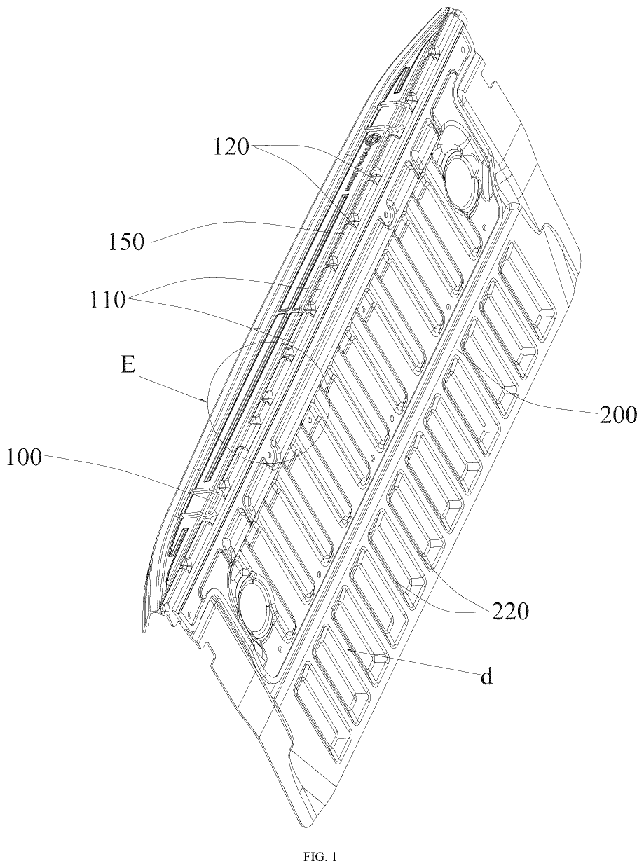

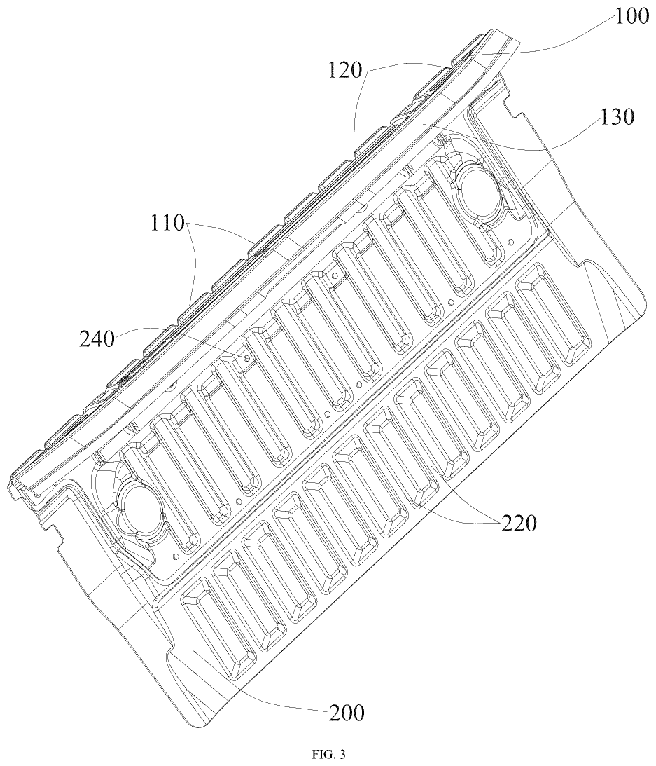

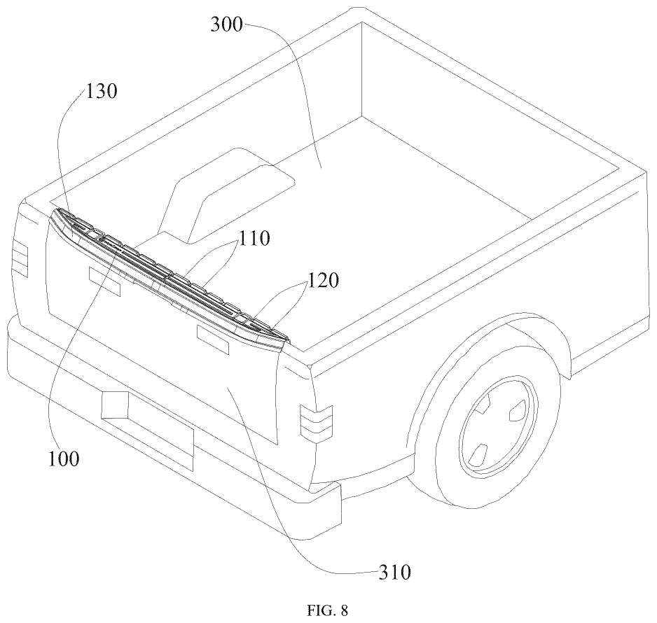

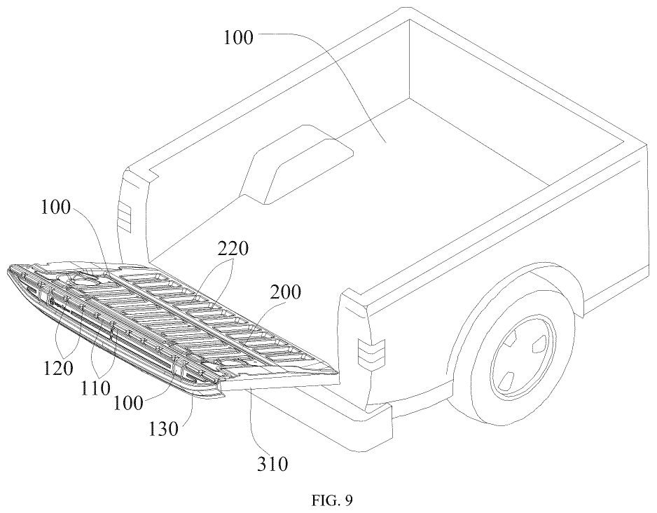

Referring to FIGS. 1 to 12, a tailgate mat for installation on a tailgate 310 of a cargo compartment 300 of pickup truck. The tailgate mat includes a border 100 and a supporting component 150

The border 100 is configured to wrap an upper end of the tailgate 310. The supporting component 150 is located on the border 100.

When the cargo compartment 300 bears goods 400, a first end of the goods 400 is abutted against a front bottom of the cargo compartment 300, and a second end of the goods is supported by the supporting component 150, with an angle α is defined between a supporting force from the supporting component 150 on the goods 400 and a vertical direction is less than 45°, thereby providing the goods 400 with more stable cushioning and better support.

Through this structure, the border 100 can wrap an upper end of the tailgate 310 to prevent scratches and damage during transportation or when carrying long-sized goods 400. The supporting component 150 located on the border 100 is directly used to support the goods 400. When transporting long-sized goods 400 in the cargo compartment 300, the first end of the goods 400 abuts against the front bottom of the cargo compartment 300, and the second end is directly placed on the supporting component 150. The inclined goods 400 relies on the supporting component 150 and a front end of the tailgate 310 to support the weight of the goods 400, concentrating a pressure of the goods 400 on the supporting component 150 and the front end of the tailgate 310. Moreover, when placing goods 400, the supporting component 150 may experience instant impacts from the goods 400, and the supporting component 150 also helps to disperse and cushion the impact force to avoid excessive concentration of force. The supporting component 150 can effectively withstand the long-term static pressure and instantaneous impacts of the goods 400, ensuring that the structure of the border 100 remains intact during frequent loading and unloading, thereby providing lasting protection for the tailgate 310 and the cargo compartment 300 from damage.

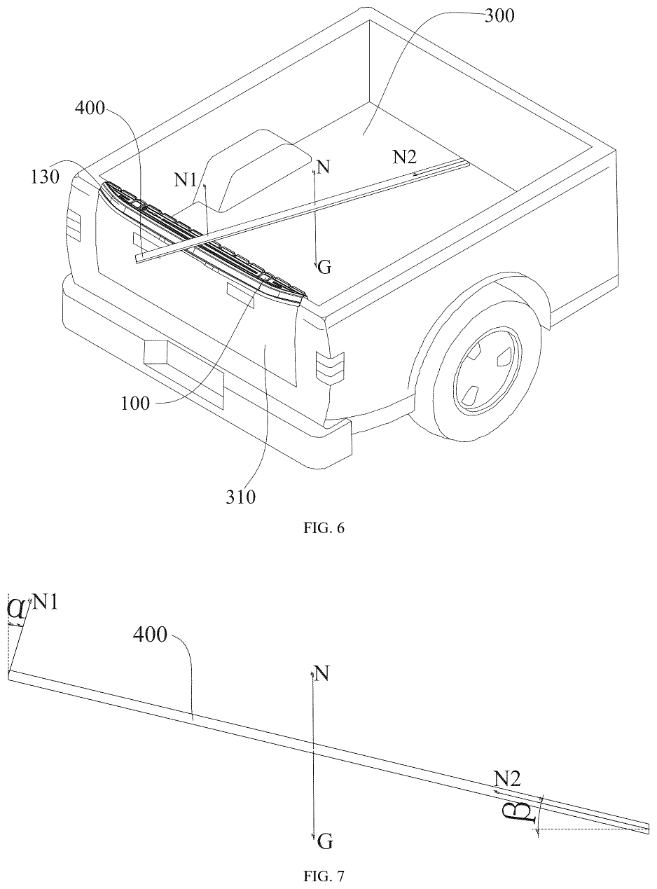

When the goods 400 is stationary and under instantaneous impact, the supporting force N1 from the supporting component 150 on the goods 400 and the supporting force N2 from the front end of the tailgate 310 on the goods 400, according to the principle of static equilibrium, a vector sum of N1 and N2 equals the weight G of the goods 400 in value. N and G are in opposite directions, at which point the goods 400 is in a state of equilibrium within the cargo compartment 300 (preferably, during transport, the goods 400 can be secured to the border 100 using a fastening strap to maintain balance). As shown in FIGS. 6, 7, and 10, defining the length, height (the vertical height when the tailgate 310 is closed), and width (the width of the cargo compartment 300 and the tailgate 310) of the cargo compartment 300 as L, H, and W, respectively, in terms of practicality, the length of the cargo compartment 300 of the sold on the market is greater than its height. In the extreme case where the length of the cargo compartment 300 equals its height, when the goods 400 is inclined within the cargo compartment 300 (with the first end abutting against the front bottom of the cargo compartment 300 and the second end supported by the supporting component 150), an angle β between the goods 400 and the bottom of the cargo compartment 300 (i.e., the horizontal direction) is 45°. According to mechanical equilibrium, the angle α between the supporting force N1 and the vertical direction is equal to β, which is 45°. However, in reality, since the length of the cargo compartment 300 is greater than its height, when placed inclined the angle β of the goods 400 will be less than 45°, meaning that the angle α of the supporting force N1 will also be less than 45°, which can satisfy the requirement for stable support for the goods 400 from the supporting component 150.

In this embodiment, the supporting component 150 is a plurality of protrusions 110 formed by extending upward from an upper surface of the border. With this structure, the plurality of protrusions 110 extend upward from the upper surface of the border 100, indicating that the plurality of protrusions 110 do not fit tightly against an upper surface of the tailgate 310. When the second end of the goods 400 is placed on the plurality of protrusions 110, the plurality of protrusions 110 can isolate a contacting point of the goods 400 from the upper edge of the tailgate 310, making this contacting point slightly higher than the upper surface of the tailgate 310. This transforms the original linear contact between the goods 400 and the border 100 into a multi-point support provided by the plurality of protrusions 110. This structure not only ensures that the plurality of protrusions 110 can provide stable supporting force N1 during both long-term static pressure and instantaneous impact from the goods 400, but also that the plurality of protrusions 110 help to distribute the local pressure exerted by the goods 400 on the border and the upper end of the tailgate 310, reducing pressure concentration and avoiding damage to the border.

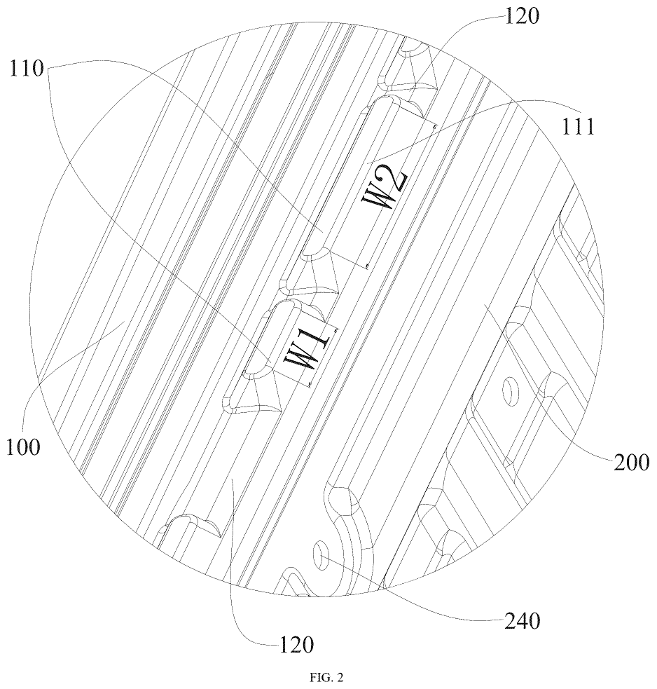

In this embodiment, each of the plurality of protrusions 110 is equipped with a bearing surface 111. When the cargo compartment 300 carries the goods 400, the first end of the goods 400 is abutted against the front bottom of the cargo compartment 300. And when the second end is supported on the bearing surface 111, the angle α between the supporting force of the plurality of protrusions 110 on the goods 400 and the vertical direction is less than 45°, ensuring that the plurality of protrusions 110 provide stable buffering and support for the goods 400. With this structure, as shown in FIG. 2, the bearing surface 111 has a smoothly transitioning structure, providing a reliable contact interface for the goods 400, allowing for different shapes of the goods 400 to rest against the surface. For long, rigid goods 400, when placed on the bearing surface 111, it still essentially maintains linear or nearly linear contact, meaning that the angle α of the supporting force N1 corresponds to the angle β between the goods 400 and the bottom plate of the cargo compartment 300. Preferably, the inclination degree of the bearing surface 111 at any point (an acute angle between its normal vector and the horizontal plane) ranges from 10° to 90°.

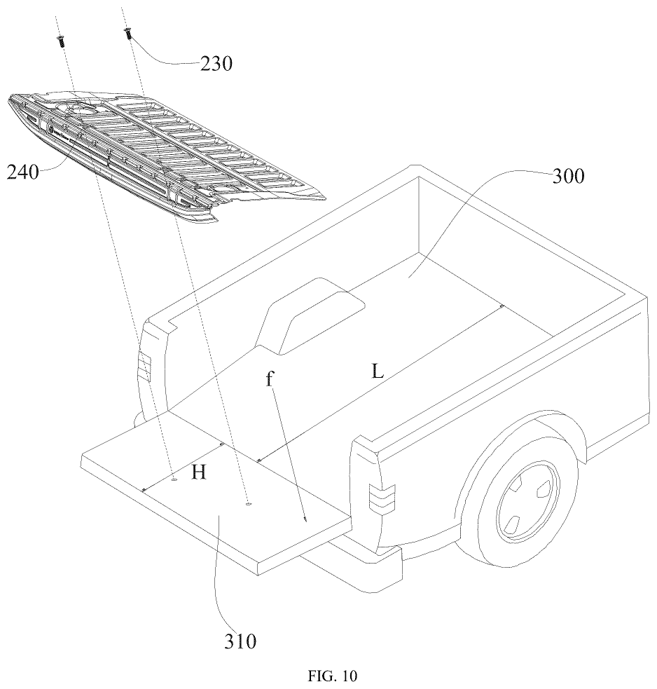

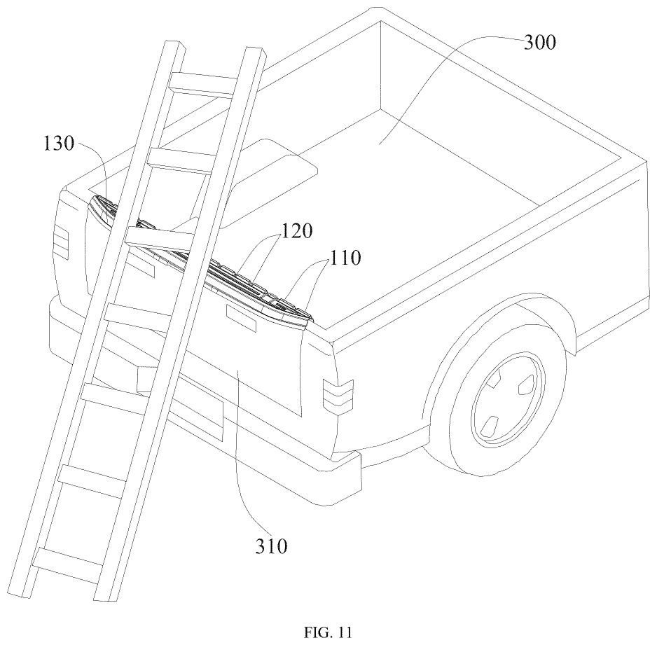

In this embodiment, the plurality of protrusions 110 are arranged on the border in the width direction of the tailgate 310, with the bearing surface 111 positioned near the inner side of the cargo compartment 300. With this configuration, as illustrated in FIG. 10, the plurality of protrusions 110 arranged in the width direction can form a continuous transverse support line along the edge of the upper end of the tailgate 310, ensuring that goods 400 of different widths receives stable and symmetrical support. Furthermore, the position of the bearing surface 111 is close to an inner side of the cargo compartment 300, causing the supporting point of the second end of the goods 400 to shift towards the interior of the cargo compartment 300, making it easier to place the goods 400 on the plurality of protrusions 110, facilitating the inclined placement of the goods 400 and ensuring more even pressure distribution on the plurality of protrusions 110. It should be noted that the plurality of protrusions 110 are located closer to the interior of the cargo compartment 300 on the border 100.

In this embodiment, the plurality of protrusions 110 and the border 100 are in an integrated structure. This integrated structure simplifies the manufacturing process, eliminating potential looseness that could arise from separate connections between the plurality of protrusions 110 and the border 100, allowing the pressure from the goods 400 to be evenly and directly distributed across several of the plurality of protrusions 110 and indirectly and uniformly transmitted to the upper surface or edge of the border. This can enhance the durability of the tailgate mat and extend its lifespan.

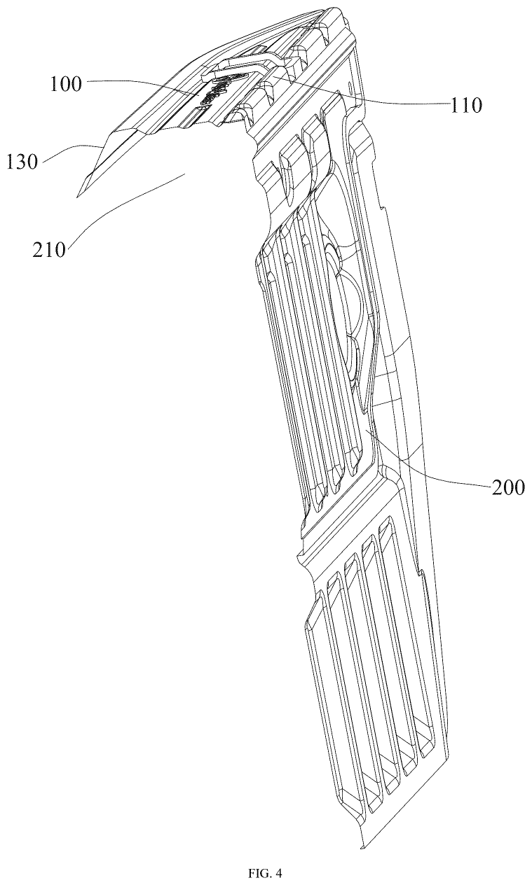

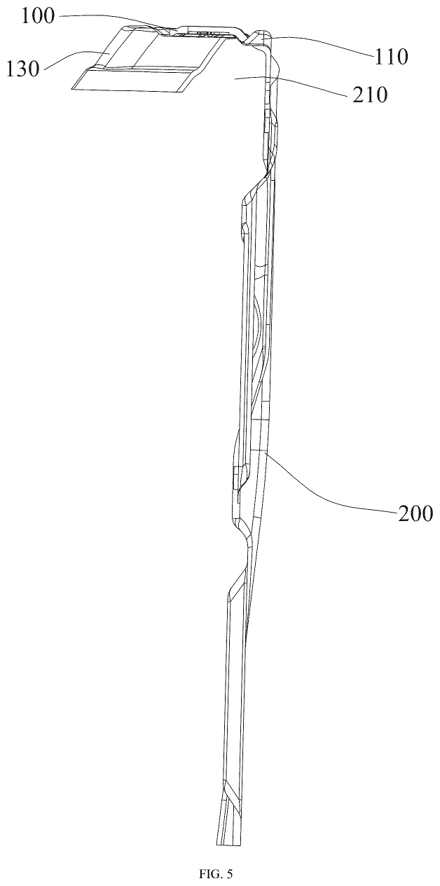

In this embodiment, a cross-section of each of the plurality of protrusions 110 is U-shaped. As shown in FIGS. 4 and 5, when viewed from the upper surface of the border 100, the plurality of protrusions 110 are generally in a rectangular shape, providing sufficient extension width and load-bearing width in the width direction of the tailgate 310, making a cross-section of the plurality of protrusions 110 U-shaped. Additionally, the U-shaped cross-section provides extra bending stiffness through the side walls of the plurality of protrusions 110, allowing them to more effectively maintain the angle α of the supporting force N1 relative to the angle β between the goods 400 and a bottom plate of the cargo compartment 300 while dispersing local pressure, thereby enhancing the reliability and durability of the border.

In this embodiment, an upper surface of the plurality of protrusions 110 is parallel to an upper surface of the tailgate 310. This structural arrangement ensures that when the border coats the tailgate 310, there is a uniform distance between the internals of the plurality of protrusions 110 and the upper surface of the tailgate 310. This allows the pressure from the goods 400 to be more uniformly and smoothly distributed to the border 100 via the sidewalls of the plurality of protrusions 110 and the surrounding structure, avoiding local stress points and better protecting both the border 100 and the tailgate 310 during long-term use. Preferably, the internals of the plurality of protrusions 110 are hollow, to ensure functionality while reducing material usage, lowering the overall weight and manufacturing costs of the border.

In this embodiment, grooves 120 are formed between the border 100 and two adjacent protrusions 110 of the plurality of protrusions 110. This structural arrangement creates a continuous drainage channel at the upper end of the border 100 between two adjacent protrusions 110. In rainy or snowy weather, rainwater on the border can be smoothly drained out through the grooves 120 to the outside of the cargo compartment 300, avoiding accumulation near the plurality of protrusions 110 that could affect normal use. Additionally, the grooves 120 enhance the structural layout of the border without impacting the functionality of the plurality of protrusions 110 by separating them, allowing users to place goods 400 more rationally. The introduction of grooves 120 also increases air and rainwater circulation in the contact area between the border and the goods 400, preventing excessive localized moisture from damaging the goods 400 due to continuous large-area contact. More importantly, the presence of grooves 120 improves the ability of the plurality of protrusions 110 to function under pressure and impacts from the goods 400: thus, the plurality of protrusions 110 can offer better strength and impact resistance. If corresponding grooves 120 are not set, and only a wide and continuous protrusion 110 exists, the force from the goods 400 cannot be effectively distributed and absorbed during pressure or impact, making it prone to deformation or damage. Additionally, the plurality of wide and continuous protrusions 110 create large areas of tight contact with the goods 400, hindering air circulation and potentially leading to cargo loss.

In this embodiment, in a width direction of the border, at least two protrusions of the plurality of protrusions 110 have different widths. By setting up the above structure, as shown in FIG. 2, one protrusion 110 is defined with a width W1 and another protrusion 110 is defined with a width W2, where W1 is not equal to W2, meaning at least two protrusions of the plurality of protrusions 110 have different widths. This design can adapt to different types of goods 400. Wider protrusions 110 can carry wider goods 400, large panels, or bundled construction materials, providing a larger contact area to effectively distribute the load and avoid local deformation of the protrusions 110. In contrast, narrower protrusions 110 are suitable for goods 400 with smaller contact surfaces, such as pipes, profiles, or trees, providing precise linear support to prevent goods 400 from rolling or slipping. This design of combining different widths enhances the adaptability of the border to goods 400 of various sizes. Furthermore, the different widths of the plurality of protrusions 110 can be reasonably optimized based on the size and weight of the goods 400, making the supporting force N1 of the plurality of protrusions 110 more balanced and stable. It is noteworthy that at least two of the grooves 120 also have different widths.

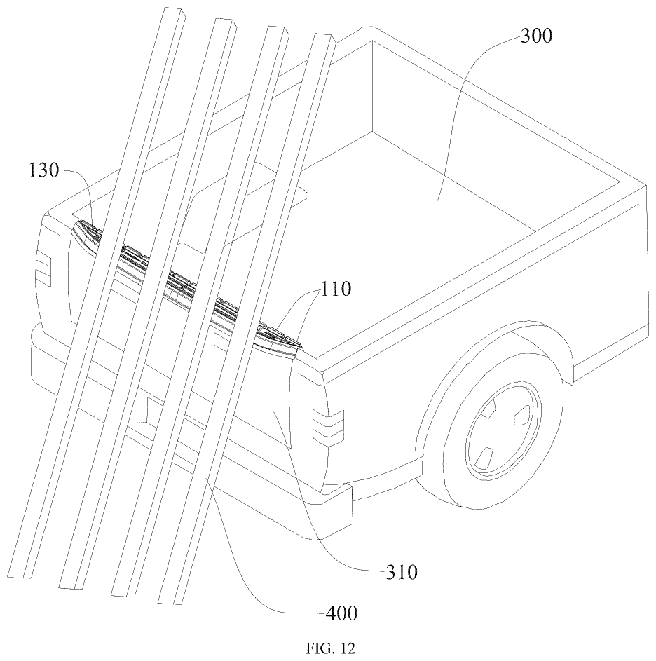

In this embodiment, the lower end of the border, which is away from the cargo compartment 300, is provided with an anti-slip inclined surface 130, which is used to support the goods 400 when the tailgate 310 is closed. With this structure, the anti-slip inclined surface 130 not only provides additional positioning and anti-slip protection for the goods 400 when the tailgate 310 is closed but also further expands the application scenarios. As shown in FIGS. 11 and 12, on one hand, some goods 400 (such as wood or decorative materials) may need temporary airing or display. When the tailgate 310 is closed, one end of the goods 400 can be supported on the ground while the other end rests against the anti-slip inclined surface 130, which provides stable support for the goods 400. On the other hand, for some cargo compartments 300 that are higher off the ground, when the tailgate 310 is closed, users can use the anti-slip inclined surface 130 to support tools such as ladders or stepping platforms, creating a safe and convenient climbing point for accessing the cargo compartment 300.

In this embodiment, the angle α is set between 14° to 45° to better meet the requirements for the plurality of protrusions 110 to provide more stable cushioning and better support for the goods 400. Based on the investigation of pickup trucks, the market primarily categorizes them into three types according to the length-to-height ratio of the cargo compartment 300. The first type is the length-to-height ratio of the compartment pickup 300 of pickup truck between 2.8 and 3.8: the length-to-height ratio of the compartment pickup 300 of pickup truck between 3.3 and 3.8; and the third is the rarely used extra-long cargo compartment, where the length-to-height ratio is between 3.8 to 5.6. For mainstream pickup trucks, the length-to-height ratio of the cargo compartment 300 is generally between 1 to 4. When the length-to-height ratio is 4, and goods 400 are placed at an incline inside the cargo compartment 300, the angle between the goods 400 and the cargo compartment 300 base is defined as a1 (defined similarly to β), the angle of the supporting force F1 relative to the vertical direction is defined as b1 (defined similarly to α). According to the Pythagorean theorem and static equilibrium principles, when 14.04°<a1=b1, it can be concluded that when a is between 14° to 45°, it better suits the mainstream pickups on the market, providing more stable support for the goods 400.

In this embodiment, the tailgate mat also includes a main body 200, which connects to the bottom end of the border on the side close to the cargo compartment 300, and the main body 200 is configured to cover an inner surface of the tailgate 310. Through this structure, some shorter goods 400 (which are less than the length of the cargo compartment 300) can be directly placed inside the cargo compartment 300. During transportation, shorter goods 400 placed in the cargo compartment 300 may inevitably sway, causing scraping against the inner surface of the tailgate 310. The main body 200 covers this inner surface, directly isolating the shorter goods 400 from contact with the tailgate 310, thus preventing damage to it.

In this embodiment, the border 100 and a back surface of the main body 200 jointly define an installation slot 210, which allows the upper end of the tailgate 310 to be inserted. The setup of this structure allows the anti-slip inclined surface 130, formed by the border 100 extending downward away from the cargo compartment 300, to jointly define the installation slot 210 with the back surface of the main body 200. This installation slot 210 can match and fit with the upper edge of the tailgate 310, facilitating the installation of the tailgate mat. Users simply need to align the installation slot 210 with the upper end of the tailgate 310 and fully place the slot to complete the installation. The installation slot 210 acts as a guide for matching and precise fitting during installation, ensuring the compatibility of the tailgate mat with the tailgate 310. It should be noted that the border 100 mainly includes a horizontal first edge (where the plurality of protrusions 110 are located) and a vertical second edge (where the anti-slip inclined surface 130 is located), with the installation slot 210 enclosed and defined by the first edge, the second edge, and part of the main body 200. As shown in FIG. 1, the front surface of the main body 200 is indicated by arrow d, and the opposite side is the back surface.

In this embodiment, a cross-section of the installation slot 210 is U-shaped. Through this structure, as shown in FIGS. 4 and 5, the U-shaped design of the installation slot 210 is intended to match the specific geometric shape of the upper edge of the tailgate 310, increasing the contact area between the border 100 and the tailgate 310, effectively dispersing pressure during loading and unloading of goods 400 or while placing ladders on the border. This cooperative relationship enables the installation slot 210 to be securely clipped onto the upper end of the tailgate 310. Preferably, the size of the installation slot 210 matches the upper edge of the tailgate 310.

In this embodiment, several protruding strips 220 are arranged on a front surface of the main body 200 and/or an upper surface of part of the border 100, protruding from the front surface of the main body 200 and/or the upper surface of the border 100. Through this structure, the protruding strips 220 can increase the friction between the front of the main body 200 and the goods 400 carried in the cargo compartment 300. For some smooth or hard-surfaced goods 400, such as toolboxes or plastic containers, this can reduce swaying or movement of the smooth or hard-surfaced goods 400 due to contact with the front of the main body 200 while the pickup track is accelerating, braking, or turning. On one hand, this reduces the risk of damage caused by the goods 400 swaying: on the other hand, the protruding strips 220 also add a certain decorative effect to the front of the main body 200, balancing practicality and visual design. Besides its anti-slip function, it also acts as a reinforcing rib, enhancing the structural strength and stability of the main body 200 while preventing deformation under the pressing of the goods 400. It should be noted that the outer surface of the border 100 also features corresponding protruding strips 220, to enhance the overall structure of the border, increase friction with the goods 400 carried, and add a certain decorative effect. Additionally, several protruding strips 220 can be arranged horizontally or vertically, with a certain spacing between adjacent strips.

In this embodiment, at least one of the back surface of the main body 200, the inner surface of the tailgate 310, and the inner surface of the border is provided with an adhesive layer to fix the tailgate mat onto the tailgate 310. Through the setup of the above structure, as shown in FIG. 10, the arrow f indicates the inner surface of the tailgate 310. The adhesive layer can form a stable bond on the back surface of the main body 200 or the inner surface of the tailgate 310 or the inner surface of the border, thus firmly connecting the tailgate mat with the tailgate 310. The adhesive layer does not damage the tailgate mat itself or the tailgate 310, and there is no need to install additional connecting components on the tailgate mat and the tailgate 310. At the same time, the presence of the adhesive layer makes the disassembly and installation of the tailgate mat more convenient. The adhesive layer exists in at least one of the back surface of the main body 200, the inner surface of the tailgate 310, and the inner surface of the border. When the adhesive layer is on the back surface of the main body 200, a large-area bonding between the main body 200 and the inner surface of the tailgate 310 can be achieved. When the adhesive layer is on the inner surface of the tailgate 310, the bonding area between the main body 200 and the tailgate 310 can also be maximized. When the adhesive layer is on the inner surface of the border, i.e., the inner side of the U-shaped installation slot 210 and the non-protruding part 110, it can cooperate with the installation slot 210 to enhance the coverage tightness of the tailgate mat on the upper edge of the tailgate 310. In summary, the presence of the adhesive layer improves the convenience of the tailgate mat's assembly and disassembly, avoids damage to the structure of the tailgate mat itself, and achieves a balance between quick installation and damage-free protection.

In this embodiment, the adhesive layer is a double-sided tape. Through the setup of the above structure, the double-sided tape has high viscosity and strong adhesion, compatible with various materials and surface structures, whether on the back surface of the main body 200, the inner surface of the tailgate 310, or the inner surface of the border. The high-viscosity double-sided tape can achieve bidirectional bonding through pressure-sensitive adhesive technology, allowing users to simply press to create a strong adhesive force. Furthermore, during transportation, temperature and humidity may change, but the double-sided tape can respond to such environmental changes without altering its adhesive properties. The double-sided tape also possesses high tensile strength and compressive resistance, allowing it to disperse pressure and impacts caused by the shaking of goods 400 during transportation. Additionally, the double-sided tape features a no-trace design: when removed, it will not damage the surfaces of the tailgate 310 and the tailgate mat.

In this embodiment, a fixing component 230 is also included, with the main body 200 and/or the border provided with an installation hole 240 through which the fixing component 230 passes to fix the tailgate mat to the tailgate 310. Through the setup of the above structure, the cooperative arrangement of the fixing component 230 and the installation hole 240 provides an option for mechanical connection between the tailgate mat and the tailgate 310. Preferably, as shown in FIG. 10, the fixing component 230 is a screw that comes with the pickup truck itself. Corresponding installation holes 240 can be made in the tailgate mat based on the positions of the original screws on the tailgate 310, allowing the use of original vehicle screws to make the connection between the tailgate mat and the tailgate 310 more reliable. It is important to note that the fixing component 230 and the adhesive layer can be used together, forming a dual connection method of either “mainly with fixing component 230, supplemented by the adhesive layer” or “integrating the fixing component 230 and the adhesive layer,” combining the stability of mechanical connections with the seamless advantages of the double-sided tape, thus ensuring a solid connection between the tailgate mat and the tailgate 310. It should also be noted that the fixing component 230 and the installation hole 240 can be multiple, and a number of installation holes 240 is consistent with a number of fixing components 230, and the number of fixing components 230 is consistent with or less than the number of screws on the tailgate 310 of the pickup truck.

In this embodiment, the tailgate mat is an integrated structure. Through the setup of the above structure, the integrated structure ensures that there is no gap between the main body 200 and the border 100, fundamentally eliminating looseness that may arise from separate connections between the main body 200 and the border 100, thus better maintaining the overall integrity and functional stability of the tailgate mat. At the same time, the integrated structure simplifies the industrial production process and reduces manufacturing costs. Moreover, the integrated structure makes cleaning and replacing the tailgate mat simpler and easier, and it avoids the accumulation of dirt at the joints of separate connections.

In this embodiment, the tailgate mat is made of a thermoplastic material. Through the setup of the above structure, the thermoplastic material offers high strength, good toughness, excellent weather resistance, and impact resistance. These advantages allow the tailgate mat to maintain structural integrity and consistent functionality even when the pickup truck is in motion, facing changes in temperature, humidity, and ultraviolet light environments. The thermoplastic material can effectively resist material aging, brittleness, or deformation caused by environmental factors, ensuring durable structural integrity. Its high strength and toughness guarantee that the plurality of protrusions 110 can endure long-term goods 400 support without easily undergoing plastic deformation.

In this embodiment, the material of the tailgate mat is TPE (Thermoplastic Elastomer). Through the setup of the above structure, the tailgate mat made of TPE combines the elasticity and flexibility of traditional thermosetting rubber with the reprocessing capabilities of thermoplastic materials. Its elasticity ensures that the tailgate mat can better fit the curves of the tailgate 310, while the cushioning properties of TPE help disperse the impact force from the goods 400. Additionally, TPE's inherent slip resistance and ease of cleaning make it suitable for complex outdoor transport environments, further optimizing the overall performance of using TPE materials for protective mats. It should be noted that a Shore hardness of the TPE material used for the tailgate mat is between 30 A and 70 A. Using TPE as the material for the tailgate mat allows the plurality of protrusions 110 to relieve pressure through their deformation when supporting goods 400, providing excellent cushioning and shock absorption.

The above is a description of one or more embodiments provided in conjunction with specific content and does not limit the specific implementation of this disclosure to these statements. Any method, structure, etc., that is similar to or the same as this disclosure, or any technical derivations or substitutions made based on the concepts of this disclosure, should be regarded as being within the scope of protection of this disclosure.

What is claimed is:

1. A tailgate mat for installation on a tailgate of a cargo compartment of a pickup truck, comprising:
a border, which is configured to wrap around an upper end of the tailgate;
a supporting component, which is located on the border;
wherein, when the cargo compartment bears goods, a first end of the goods is abutted against a front bottom of the cargo compartment, and a second end of the goods is supported by the supporting component: an angle between a supporting force of the supporting component on the goods and a vertical direction is defined as a, wherein a is less than 45°, to provide stable cushioning and support for the goods.

2. The tailgate mat according to claim 1, wherein the supporting component comprises a plurality of protrusions formed by extending upwards along an upper surface of the border.

3. The tailgate mat according to claim 2, wherein the plurality of protrusions is provided with a bearing surface: wherein when the cargo compartment bears goods, the first end of the goods is abutted against a front bottom the cargo compartment and the second end of the goods is supported by the bearing surface, the angle between the supporting force of the plurality of protrusions on the goods and the vertical direction is a, where a is less than 45°, to provide stable cushioning and support for the goods.

4. The tailgate mat according to claim 3, wherein the plurality of protrusions is arranged on the border along a width direction of the tailgate, and the bearing surface is located near an inner side of the cargo compartment.

5. The tailgate mat according to claim 2, wherein the plurality of protrusions and the border are in an integrated structure.

6. The tailgate mat according to claim 2, wherein a cross-section of each of the plurality of protrusions is U-shaped.

7. The tailgate mat according to claim 2, wherein an upper surface of the plurality of protrusions is parallel to an upper surface of the tailgate.

8. The tailgate mat according to claim 2, wherein the tailgate mat further comprises grooves formed between the border and two adjacent protrusions of the plurality of protrusions.

9. The tailgate mat according to claim 2, wherein in a width direction of the border, at least two protrusions of the plurality of protrusions have different widths.

10. The tailgate mat according to claim 1, wherein a lower end of the border away from the cargo compartment is provided with an anti-slip inclined surface; when the tailgate is closed, the anti-slip inclined surface is configured to support the goods.

11. The tailgate mat according to claim 3, wherein a is between 14° and 45°, to ensure that the plurality of protrusions provide stable cushioning and support for the goods.

12. The tailgate mat according to claim 1, wherein the tailgate mat further comprises a main body connected to a lower side of the border near the cargo compartment, and the main body is configured to cover an inner surface of the tailgate.

13. The tailgate mat according to claim 12, wherein an installation slot is defined by the border and a back surface of the main body, which allows the upper end of the tailgate to be inserted.

14. The tailgate mat according to claim 13, wherein a cross-section of the installation slot is U-shaped.

15. The tailgate mat according to claim 12, wherein at least one of a front surface of the main body and a part of an upper surface of the border is provided with several protruding strips, which are projected from at least one of the front surface of the main body and the upper surface of the border.

16. The tailgate mat according to claim 12, wherein at least one of a back surface of the main body, the inner surface of the tailgate, an inner surface of the border is equipped with an adhesive layer, to secure the tailgate mat to the tailgate.

17. The tailgate mat according to claim 16, wherein the adhesive layer is a double-sided tape.

18. The tailgate mat according to claim 12, wherein the tailgate mat further comprises a fixing component, and at least one of the main body and the border is defined with an installation hole; the fixing component is passed through the installation holes to secure the tailgate mat to the tailgate.

19. The tailgate mat according to claim 1, wherein the tailgate mat is an integrated structure.

20. The tailgate mat according to claim 1, wherein the tailgate mat is made of thermoplastic material.
